(19) United States
(12) Patent Application Publication
(10) Pub. No.: US 2002/0118883 A1
(43) Pub. Date: Aug. 29, 2002

(54) Classifier-based enhancement of digital images

(76) Inventor: Neema Bhatt, New Berlin, WI (US)

Correspondence Address: EXIM CONSULTING, LLC, 4915 S. RADISSON CT., NEW BERLIN, WI, 53151, US

(21) Appl. No.: 09/681,212

(22) Filed: Feb. 24, 2001

(51) Int. Cl. G06K 9/62; G06K 9/40

(52) U.S. Cl. 382/224; 382/274

(57) ABSTRACT

Embodiment of the present invention receives images from a database. Next, the images are sized and then grouped into different classes by a classifier. After the classification, images in each class are enhanced using steps including the dynamic range management, noise reduction, blur removal, color correction, and background modification. The image files are iteratively ascertained to have smaller than a pre-specified file size. Next, the enhanced images can be pushed back to the database through a variety of means.

### BACKGROUND OF INVENTION

1. Technical Field

The present invention generally relates to methods and systems classifier-based enhancement of images in any image database, and more specifically, to methods and systems for a large scale image quality enhancement of digital images acquired under diverse conditions focusing on real-estate images as an example.

2. Background Art

Many industries including the real estate industry are undergoing a data revolution in terms of openness and free access to the data on the Internet. These industries are currently engaged in solving the challenges presented by the Internet such as developing software for database management, sorting and presentation, software connectivity etc. Solving these first order problems is essential to the existence of these industries on the Internet.

As an exemplary industry, I describe the prior art of real estate industry. U.S. Pat. No. 5,794,216 to Brown discloses a device for storing information about a plurality of houses, for access by an application program executed on a computer or other like programmable apparatus, comprising a computer-readable storage medium and computer-readable data on the computer-readable storage medium. The computer-readable data is representative of a database containing textual information for each house, at least one exterior image for each house, at least one interior image for each house, and at least one parameter indicating a portion of the exterior image corresponding to the interior image for each house, all in a common database format. Methods, systems, and articles of manufacture for compiling information about a house on a computer-readable storage medium using a computer are disclosed. U.S. Pat. No. 5,235,680 to Bijnagte discloses a multimedia database system for maintaining a database containing listings of real estate properties on the market. The system is capable of storing, retrieving, displaying, printing and manipulating color images stored in the database. Further, the system is capable of loading digitized images from remote terminals over telephone lines on an interactive basis. The system includes a multi-user host computer and a plurality of remote data terminals connected to the host computer. U.S. Pat. No. 5,146,548 to Bijnagte discloses a method and an apparatus for publishing listings of real estate properties. The method includes a step of converting photographed or videotaped images of real estate properties to digital graphics at a front end of a publishing process. Image operations, such as sizing, cropping, and digital quality enhancement are performed when the images are captured. U.S. Pat. Nos. 5,032,989 and 4,870,576 to Tornetta disclose systems having computer software for creating and maintaining a real estate property database, and for searching the database. Remote seller systems provide property information to a host system. The host system maintains a database of the property information provided thereto. A graphical locator interface allows the database to be searched using search location boundaries. U.S. Pat. No. 4,429,385 to Cichelli et al. discloses a method of retrieving classified advertising information contained within a broadcast. The classified advertising information, which may include alphanumeric and graphic information, is organized in a sequential database. Selected advertising is retrieved for display using a relational query on the sequential database.

There are, however, several second order problems yet to be addressed. One of such problems is evident by the fact that majority of the digital photographs of the real estate listings on the Internet are of very poor quality. In many digital photographs, even the property to be sold is not clearly visible. This causes problems to potential customers who might overlook a nearly perfect match to their requirements just because of the poor quality of the digital image as they move on to other properties on the Internet. A good image, on the other hand, can attract prospective buyers' attention and lead them to contacting agents. Thus bad photographs of the listings could delay in getting the property sold, while a good photograph can immensely help to get the attention of the prospective buyers.

There are a number of techniques available to enhance digital photographs. These methods require a number of steps that an individual has to manually perform for each photograph in a customized fashion. These methods are time consuming and manually intensive and are unsuitable for enhancement processing of a large number of photographs taken under diverse conditions.

While the art of transforming lower quality digital images is not novel, a system and method to transform images in a large scale to a higher quality is novel and essential for the success of various industries such as the real estate industry in the Internet age. Until now, there has been no working solution to the increasing need for semi-automating or fully automating the image enhancements steps. The current invention discloses methods and system to enhance the photo quality of a large number of images through image processing and customized programming. Such a unique system has never before been realized to streamline enhancing a large number of digital images for Internet postings.

### SUMMARY OF THE INVENTION

It is an objective of the present invention to provide a novel automated method with minimal manual interactions to enhance the images from diverse sources.

Another objective of the present invention is to perform automation by using a classifier to guide the enhancement processes.

Yet another objective of the present invention is to provide an Internet marketing tool that saves time and money to professional in various industries including the real estate.

By classifying the images into different groups and enhancing them in an automated fashion, embodiments of the present invention provide advantages over manual approaches of the prior art with regard to ease of use and substantially improved throughput to be able to handle large amounts of images warranted by electronic commerce.

These and other features, aspects, embodiments, and advantages of the present invention will become better understood with regard to the following description, appended claims, and accompanying drawings.

### BRIEF DESCRIPTION OF DRAWINGS

FIG. 1 is the Method A to incorporate the present invention in practice.

FIG. 2 is the Method B to incorporate the present invention in practice.

FIG. 3 is the Method C to incorporate the present invention in practice.

FIG. 4 is the Method D to incorporate the present invention in practice.

FIG. 5 is the flow diagram of the method for the classifier-based image enhancement.

FIG. 6 is the Manual Classifier for the classification of images into a plurality of groups.

FIG. 7 is the Automated Classifier for the classification of images into a plurality of groups.

FIG. 8 is the flow diagram of the preferred embodiment of image enhancement steps.

FIG. 9 is the flow diagram of the steps for automated dynamic range management.

FIG. 10 is the flow diagram of the steps for semi-automated dynamic range management.

FIG. 11 is the flow diagram of the steps for automated random noise reduction scheme

FIG. 12 is the flow diagram of the steps for semi-automated structural noise reduction.

FIG. 13 is flow diagram of the steps for the automated blur removal from images.

FIG. 14 is flow diagram of the steps for the automated sharpening of images.

FIG. 15 is the flow diagram of the steps for automated color correction of images.

FIG. 16 is flow diagram of the steps for the background modification of images.

### DETAILED DESCRIPTION

Embodiment of the present invention, using real estate as an example, can receive data directly, or from a database. Other arrangements for receiving image data include being a direct part of the software that provides real estate infrastructure or indirectly from the software via the Internet. After receiving the images, the images are grouped into different classes by a classifier, which may be manual, or automated. After the classification, images in each class are semi-automatically or automatically enhanced using five intermediate steps, which can be combined in any order or a sub-set of these steps could be used for any given class. The steps include the dynamic range management, noise reduction, blur removal, color correction, and background modification. After the enhancement processing is complete, the enhanced images can be pushed back to the real estate database through a variety of means including, ftp, http, CD, intranet, wireless link etc.

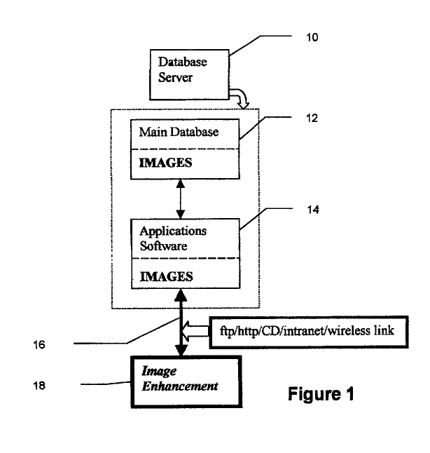

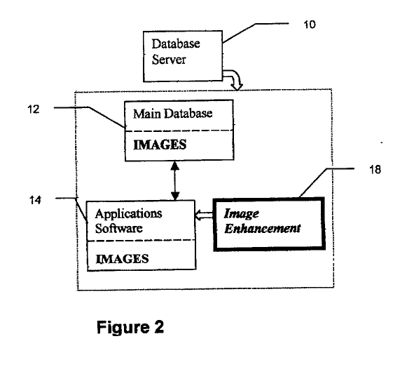

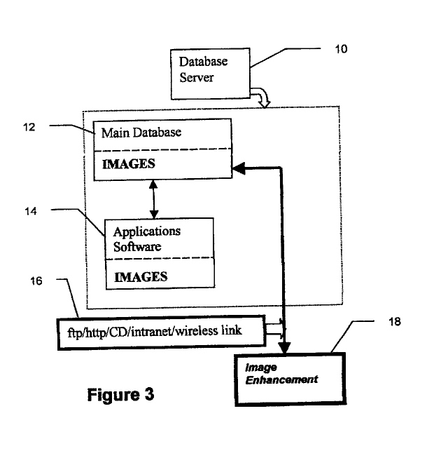

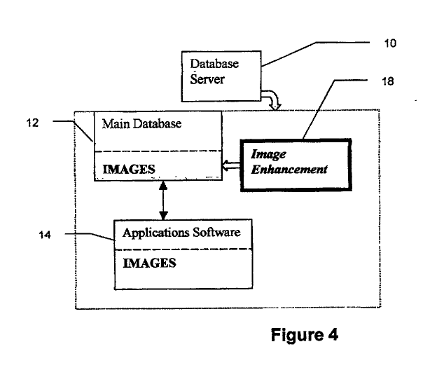

The database server provides linkage to the database and the software for the database management, sorting, presentation, connectivity etc. FIGS. 1-4 describe how the present invention fits in the workflow. Each of these figures shows a different embodiment of the use of the present invention even though all the building blocks are the same. FIG. 1 shows Method A, in which the real estate database server 10 consisting of the image database 12 containing images. The Applications software 14 can extract images from the database 12. The current invention 18, in one form, can pull images from the database 12 with the help of the Applications software 14 via various means including any one of but not limited to ftp, http, CD, intranet, or wireless link. The present invention classifies and enhances the images and the enhanced images are pushed back to the database with any one of ftp, http, CD, intranet, or wireless link. FIG. 2 shows Method B in which the real estate database server 10 includes the current invention 18 as a part of the Applications software 14 for database management. FIG. 3 shows Method C in which the present invention 18 pulls images from the database directly through ftp/http/CD/intranet/wireless link 16 and after the classification and enhancement pushes the images back into the database 12. FIG. 4 shows Method D in which the present invention 18 resides as an external application to the real estate database 12, but is physically not a part of the Application software 14.

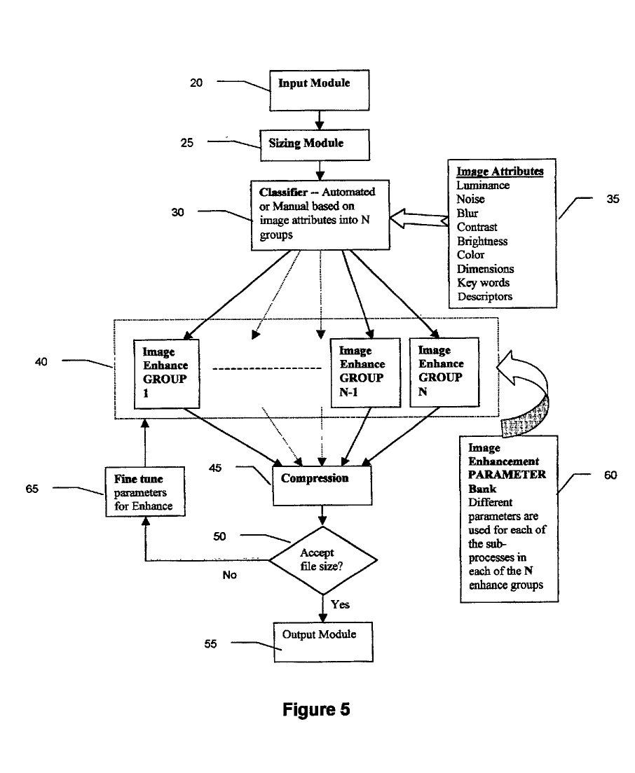

Having mentioned, where the present invention fits in an industrial workflow, now we turn to FIG. 5 to describe the semi-/fully automated image enhancement system. The image enhancement system consists of a Input Module 20 to receive images which may be gray scale or color and may be in any standard format including but not limited to JPEG, GIF, TIFF, PPM, PGM, RAW, DICOM etc. Next the Sizing Module 25 processes input images. The Sizing Module 25 converts the input images to appropriate physical dimensions such as width and height, which may be pre-defined for Internet listings. Next the Classifier 30 processes the images. The classifier may be automated or manual and uses image attributes including but not limited to the image attributes listed in element 35. The image attributes that are most useful for this purpose include luminance, noise level, blur, contrast, brightness, color, dimensions, key words, descriptors etc. These attributes allow input images into plurality of groups. After classification, the image enhancement module 40 processes the images. Each of the groups can have up to five different sub processes, with each sub process having its own lookup table containing parameters. All these lookup tables containing parameters are in the image enhancement parameter bank described by the element 60. These parameters are optimized for the enhancement of each group of images from the classifier 30. Each image after enhancement goes through a file size check in element 45. If acceptable, pre-determined file size is not achievable as determined by the decision element 50, the image parameters are fine tuned by the element 65 and the image goes through the enhancement-processing step 40 again. If the file size is acceptable, the images go to the Output Module 55. The Output Module 55 contains means to save images in an appropriate standard format for a given real estate database.

Having described the schematic of the present invention, we focus on the key individual elements of the schematic.

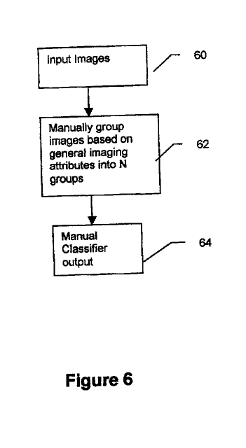

Accordingly, turning our attention to FIG. 6, we describe the manual classifier. It consists of means 60 to input appropriately sized images as previously described into it. Next, in element 62, an observer manually classifies the images into various groups by looking at representative sample images. In this manual classifier 62, subjectivity of the observer plays an important role. The classified groups go into the next processing step 64.

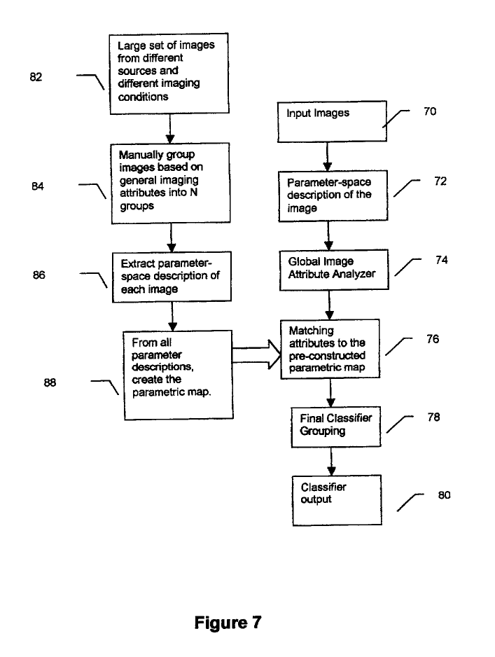

Next, turning to our attention to FIG. 7, we describe an automated classifier. Automated classifier can be fuzzy logic based, or artificial neural network-based, or Bayesian, or statistical, or heuristic or a combination type. In any technique, the automated classifier requires a training step, which is generally performed using element 82, which is a large set of image data from different sources and different imaging conditions. A domain expert in the image quality will then manually group representative images into a plurality of groups based on general imaging attributes according to the element 84. From these groupings, a parameter space description of each image is obtained according to element 86. Using the parameter space description, a parameter map is created using element 88. Following the training step, the classifier is ready for the analysis step. In this step, the input images from step 70 will have their parameter-space description extracted in element 72. A global image attribute analyzer 74 analyzes the parametric description and according to the element 76, matches the current attributes with the pre-constructed parameter map from the training step. Based on the output of the element 76, final classifier grouping is performed using the element 78. Finally, the classifier output 80 is obtained.

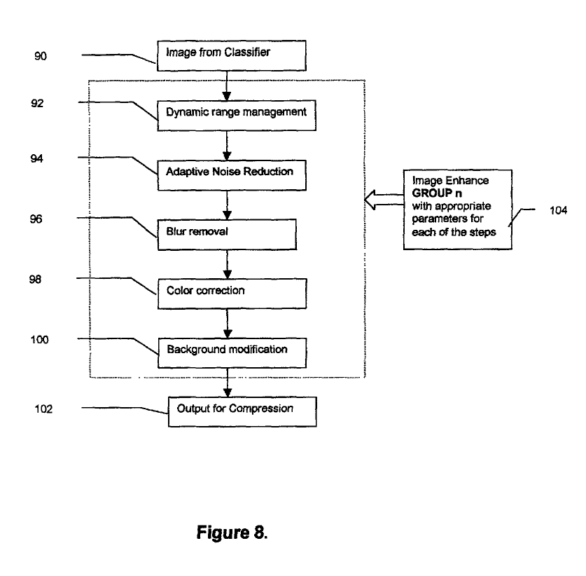

Next we turn our attention to the image enhancement steps described in FIG. 8. There are five intermediate steps in the enhancement process and these can be combined in any order or a sub-set of these steps could be used for any given class of images. The decision is made based on the image classifier.

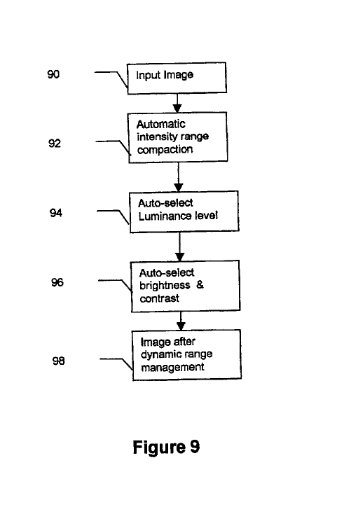

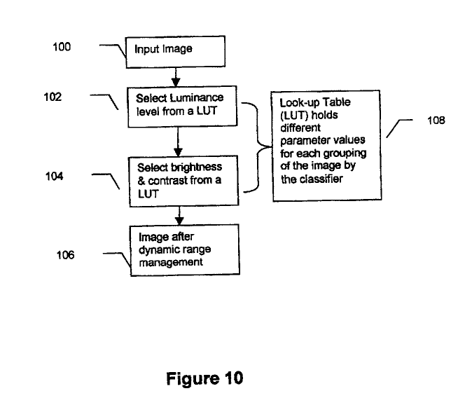

In the preferred embodiment, images are passed through element 92 to perform dynamic range management. This step essentially consists of representing the intensity of the image most optimally for viewing on the web browsers. The details of element 92 are described in FIGS. 9 and 10. Turning to FIG. 9, we describe the schematic of the steps for automated dynamic range management. The input image 90 is first subjected to the automatic intensity range compaction 92. This is accomplished in the preferred embodiment by decreasing the amount of low frequency variations in the input image 90. Next step is to automatically select the optimal luminance level using the element 94. After the intensity compaction, the median value of the histogram would give the luminance level. The goal of step 94 is to prevent having too much dark areas and bright areas in the image since they distract the visual task of looking at an image. Selection of appropriate levels also helps in the next task of choosing appropriate brightness and contrast in the image according to element 96. After fixing the level, the optimal brightness and contrast values can be derived by varying the width of the input/output transfer function. After the brightness/contrast selection, we obtain the image after the proper dynamic range management. Alternatively, the dynamic range management can be carried out in semi-automated manner as described in FIG. 9. In this method, the luminance level of the input image 100 is selected from a lookup table (LUT) as shown by element 102. Similarly, the brightness and contrast values are also obtained from the LUT as shown by element 104. Note that the LUT holds different parameter values for each grouping of the image by the classifier as shown by element 108.

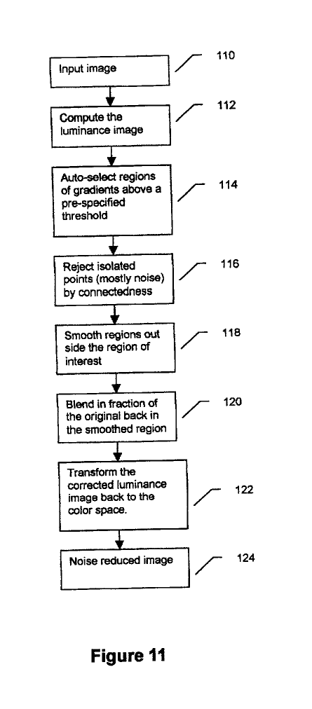

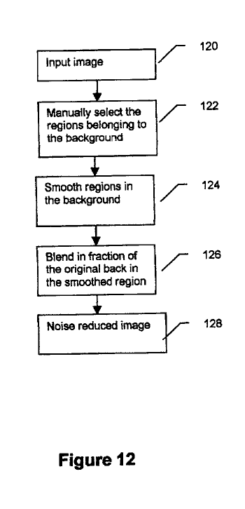

Turning back to FIG. 8, we describe the adaptive noise reduction as shown in element 94. The details of the adaptive noise reduction are described in FIGS. 11 and 12. Turning to FIG. 11, we compute the luminance image 112 from the input image 110. Next, we select regions of gradients over a pre-specified threshold as indicated by element 114 and reject isolated noisy points in the region of gradients by connectedness of points as shown in 116. Now high gradient regions without isolated high gradients form the foreground regions while the remaining regions form the background. Smooth background regions using a traditional smoothing filter, and blend a fraction of the original back in the smoothed region as indicated by the element 120. Using the original hue and saturation and the modified luminance, obtain the final image 124 using the step 122. Alternatively, semi-automated structural noise reduction method can be used where appropriate as shown in FIG. 12. Referring to the FIG. 12, the user can manually select the regions belonging to the background 122 from the input image 120. Smooth regions in the background according to the element 124 and blend in a fraction of the original back in the smoothed region 126 to obtain the noise reduced image 128.

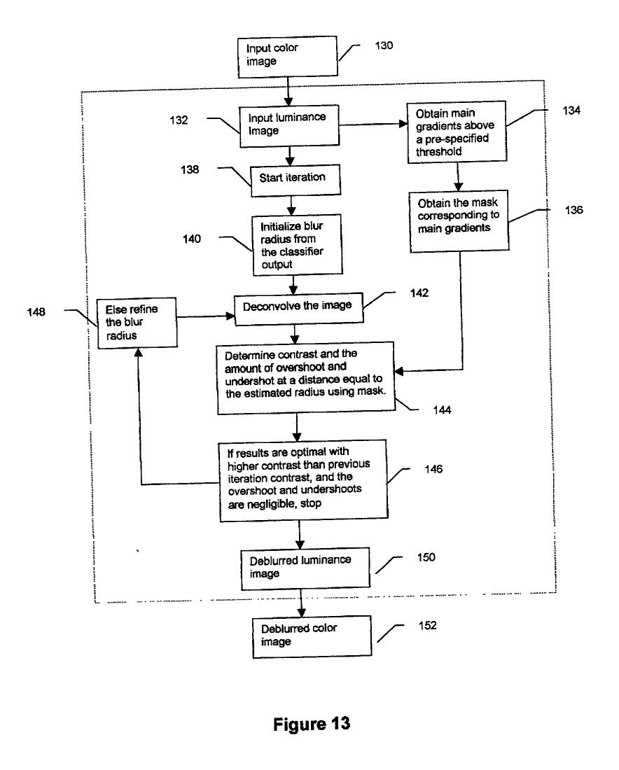

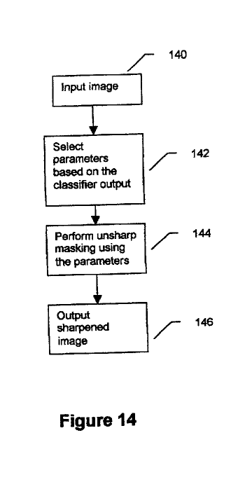

Turning back to FIG. 8, we describe the blur removal step as shown in element 96. The details of the blur removal are described in FIGS. 13 and 14. Turning to FIG. 13, we compute the luminance image 132 from the input image 130. Next, obtain main gradients above a pre-specified threshold as in 134 and the mask 136 corresponding to main gradients. Next, initialize the iteration loop 138 with the initial estimates for the blur radius 140 from the classifier output. Deconvolve the image using Weiner method as in 142. Determine contrast and the amount of overshoot and undershoot at a distance equal to the estimated radius using mask as in 144. If results are optimal with higher contrast than previous iteration contrast, and the overshoot and undershoots are negligible, stop the iteration as in 146. Otherwise, modify the blur radius as in 148 and repeat elements 142, 144 and 146 until the deblurred luminance image 150 is obtained. Using the original hue and saturation and the modified luminance, obtain the final image 152 from 150. Alternatively, non-iterative blur reduction method can be used where appropriate as shown in FIG. 14. Referring to the FIG. 14, the input image 140 is sharpened using the unsharp masking technique 144 and using the parameters based on the classifier output 142. The sharpened output image thus obtained is indicated by the element 146.

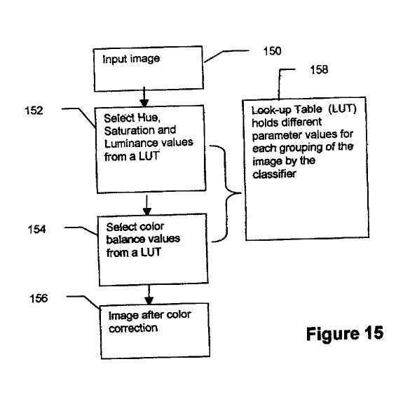

Turning back to FIG. 8, we describe the color correction as shown in element 98. The details of the color correction are described in FIG. 1 5. Turning to FIG. 15, the hue, saturation and the luminance values of the input image 150 are selected from a lookup table (LUT) as shown by element 152. Color balance values are also obtained from the LUT as shown by element 154. Note that the LUT holds different parameter values for each grouping of the image by the classifier as shown by element 158. Using the above steps, the image after color correction 156 is obtained.

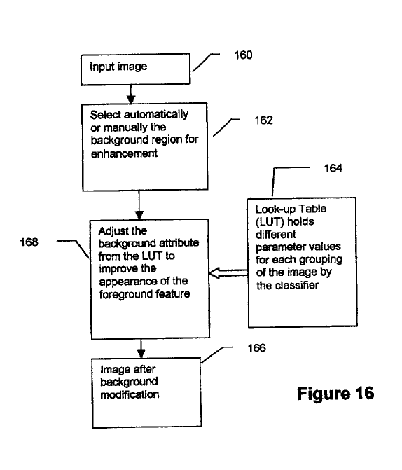

Turning back to FIG. 8, we describe the color correction as shown in element 100. The details of the color correction are described in FIG. 16. In FIG. 16, the background region 162 of the input image 160, is selected automatically or manually for enhancement. Adjust the background attribute from the LUT to improve the appearance of the foreground feature as indicated in 168. Note that the LUT holds different parameter values for each grouping of the image by the classifier as shown by element 164. Using the above steps, the image after background modification 166 is obtained.

Turning back to FIG. 8, we obtain the output for compression 102 to modify the file size. This is the step referred back in FIG. 5 as step 45. If acceptable, pre-determined file size is not achievable as determined by the decision element 50, the image parameters are fine tuned by the element 65 and the image goes through the enhancement-processing step 40 again. If the file size is acceptable, the images go to the Output Module 55. The Output Module 55 contains means to save images in an appropriate standard format for a given database.

It should be noted that the present invention might be used in a wide variety of different constructions encompassing many alternatives, modifications, and variations, which are apparent to those with ordinary in the art. Accordingly, the present invention is intended to embrace all such alternatives, modifications, and variations as fall within the spirit and broad scope of the appended claims.

1. A method of enhancing digital images on a computer-readable storage medium using a computer or other like programmable apparatus having a processor and a memory, said method comprising:
receiving images and related pertinent information from a database;
classifying said images into plurality of groups;
enhancing said images in each said group; and
sending said enhanced images to the database.

2. The method of claim 1 wherein said classifier means uses at least one of the methods including fuzzy logic, artificial neural networks, Bayesian, statistical, heuristic, genetic algorithm, and manual.

3. The method of claim 2 wherein classifying means incorporates attributes comprising luminance, noise level, blur, contrast, brightness, colors, dimensions, key words, and descriptors.

4. The method of claim 1 wherein enhancement of each group of images is accomplished using different sets of parameters.

5. The method of claim 4 wherein the enhancement step consists of intermediate steps including dynamic range management, noise reduction, blur removal, color correction, and background modification.

6. The intermediate step of claim 5 wherein dynamic range management comprises the steps of:
selecting parameters based on the classifier grouping;
automated compaction of pixel intensity range;
automated selection of the luminance level; and
automated selection of brightness and contrast.

7. The intermediate step of claim 5 wherein dynamic range management consists of lookup table usage comprising the steps of:
selecting the luminance level from a lookup table; and
selecting brightness and contrast from a lookup table.

8. The intermediate step of claim S wherein noise reduction comprises the steps of:
selecting parameters based on the classifier grouping;
computing the luminance image;
selecting regions corresponding to gradient value higher than a prespecified threshold gradient;
rejecting isolated regions of high gradients by using connectedness; and
combining a fraction of the original luminance image back in the smoothed regions.

9. The intermediate step of claim S wherein noise reduction comprises the steps of:
selecting parameters based on the classifier grouping;
computing the luminance image;
selecting the region belonging to the background;
smoothing region in the background; and
combining a fraction of the original luminance image back in the smoothed region.

10. The intermediate step of claim 5 wherein blur removal comprises the steps of:
selecting parameters based on the classifier grouping;
computing the luminance image;
computing a mask corresponding to main gradients;
deconvolving the image using appropriate blur radius;
replacing the deconvolution results in pixels corresponding to the mask; and
iteratively refining the deblurred images based on an appropriate criterion.

11. The intermediate step of claim 5 wherein blur removal with slightly blurred images can comprise the steps of:
selecting parameters based on the classifier grouping;
computing the luminance image;
selecting parameters based on the classifier output; and performing unsharp masking.

12. The intermediate step of claim 5 wherein color correction comprises the steps of:
selecting parameters based on the classifier grouping;
selecting the hue, saturation, and luminance values using parameters; and
selecting color balance values using parameters.

13. The intermediate step of claim 5 wherein background modification comprises the steps of:
selecting parameters based on the classifier grouping;
selecting the background region for enhancement; and
adjusting the background attribute from the parameter to improve the appearance of the foreground feature.

14. Method of claim 1 wherein the means for managing image file sizes consists of the steps of:
resizing images according to predefined specification prior to said classification step; and
iteratively refining parameters to attain certain predefined file size during said enhancement step to form the output image.

15. A system of enhancing digital images on a computer-readable storage medium using a computer or other like programmable apparatus having a processor and a memory, the system comprising:
means to receive images and related pertinent information from a database;
means to classify said images into plurality of groups;
means to enhance said images in each said group using different sets of parameters; and
means to send said enhanced images to the database.

16. A method to improve the visual quality of digital images generated from a plurality of imaging devices on a computer-readable storage medium using a computer or other like programmable apparatus having a processor and a memory, the method consisting steps of:
classifying images into a plurality of groups based on attributes;
and enhancing each group of images using different sets of parameters.

17. A system to improve the visual quality of digital images generated from a plurality of imaging devices on a computer-readable storage medium using a computer or other like programmable apparatus having a processor and a memory, the system consisting steps of:
classifying images into a plurality of groups based on attributes;
and enhancing each group of images using different sets of parameters.

18. A method for automation of quality enhancement for digital images acquired from at least one data source, achieved in at least one data base, and posting the output on the internet or intranet using a computer or other like programmable apparatus having a processor and a memory, said method comprising:
receiving images and related pertinent information from a database;
enhancing images automatically with minimal user interaction;
sending said enhanced images to the database; and
posting enhanced images on the internet or intranet with other pertinent information.
